(19) United States
(12) Patent Application Publication
(10) Pub. No.: US 2014/0064633 A1
(43) Pub. Date: Mar. 6, 2014

(54) IMAGE PROCESSING APPARATUS AND IMAGE PROCESSING METHOD

(71) Applicant: CANON KABUSHIKI KAISHA, Tokyo (JP)

(72) Inventor: Kaori Taya, Yokohama-shi (JP)

(73) Assignee: CANON KABUSHIKI KAISHA, Tokyo (JP)

(21) Appl. No.: 13/975,840

(22) Filed: Aug. 26, 2013

(30) Foreign Application Priority Data
Aug. 29, 2012 (JP) 2012-188785

(51) Int. Cl. G06T 5/00; G06T 5/20

(52) U.S. Cl. CPC G06T 5/001; G06T 5/20
USPC 382/261

(57) ABSTRACT

The present invention controls blur and sharpness according to a depth without performing processes repeatedly for each object determination or for each distance. A filter for a target pixel is determined by comparing multiple thresholds representing an optical characteristic of an image capturing unit and multiple values representing distance to a subject in the target pixel and pixels around the target pixel. Then, the filter is applied to the target pixel.

### BACKGROUND OF THE INVENTION

1. Field of the Invention

The present invention relates to an image processing apparatus and an image processing method which executes image processing on image data according to depth information.

2. Description of the Related Art

Recently, an image processing technique using not only information obtained from an image but also depth information of the image is attracting attention. For example, controlling blur and sharpness of the image according to the depth information of the image makes it possible to change the image capturing distance and the depth of field after the image capturing and to improve a three-dimensional appearance of the image displayed on a display.

In a method described in Japanese Patent Laid-Open No. 2010-152521, the three-dimensional appearance can be improved by determining a region of an object in an image and then executing different sharpening, smoothing, and contrast controls for the object region and a region other than the object region.

In a method described in Japanese Patent Laid-Open No. 2002-24849, an effect of a depth of field can be produced by repeating processes of blurring objects and of making the objects semi-transparent from an object farther away in an image and then by combining images.

However, Japanese Patent Laid-Open No. 2010-152521 has a problem that the image is unnatural because a process switches to a different process at a boundary between the object region and the region other than the object region. Moreover, Japanese Patent Laid-Open No. 2002-24849 has a problem that the process is slow due to the repetitive execution of the process.

### SUMMARY OF THE INVENTION

The present invention executes a filtering process on image data according to depth information of the image in a simple configuration, thereby controlling blur and sharpness according to the depth.

An image processing apparatus of the present invention includes: a determination unit configured to determine a filter for a target pixel by comparing multiple thresholds relating to an optical characteristic of an image capturing unit and multiple values representing distances to a subject in the target pixel and pixels around the target pixel; and a filter unit configured to apply the filter to the target pixel.

In the present invention, a filtering process according to depth information of an image can be executed in a simple configuration.

Further features of the present invention will become apparent from the following description of exemplary embodiments (with reference to the attached drawings).

### BRIEF DESCRIPTION OF THE DRAWINGS

FIG. 1 is a view showing an example of an image processing apparatus in Embodiment 1;

FIG. 2 is a view showing an example of a flowchart of an image processing method in Embodiment 1,

FIG. 3 is a flowchart showing an example of threshold matrix creating process in Embodiment 1,

FIGS. 4A to 4C are views showing examples of a threshold matrix in Embodiment 1,

FIG. 5 is a flowchart showing an example of a filter creating process in Embodiment 1,

FIGS. 6A to 6F are views showing an outline of the filter creating process in Embodiment 1,

FIGS. 7A to 7B are views showing an example of a filter created in Embodiment 1, and

FIGS. 8A to 8H are views showing an outline of a filter creating process in Embodiment 2.

### DESCRIPTION OF THE EMBODIMENTS

The present invention is described in detail based on preferred embodiments thereof, with reference to the attached drawings. Note that configurations shown in the following embodiments are merely examples and the present invention is not limited to the illustrated configurations.

### Embodiment 1

In the embodiment, description is given of an image processing apparatus configured to execute a blurring process according to the depth. Specifically, the image processing apparatus executes a process of: determining a filter size of a smoothing filter by using depth information; and changing a filter shape by using depth information of surrounding pixels in the filter.

### <Image Processing Apparatus>

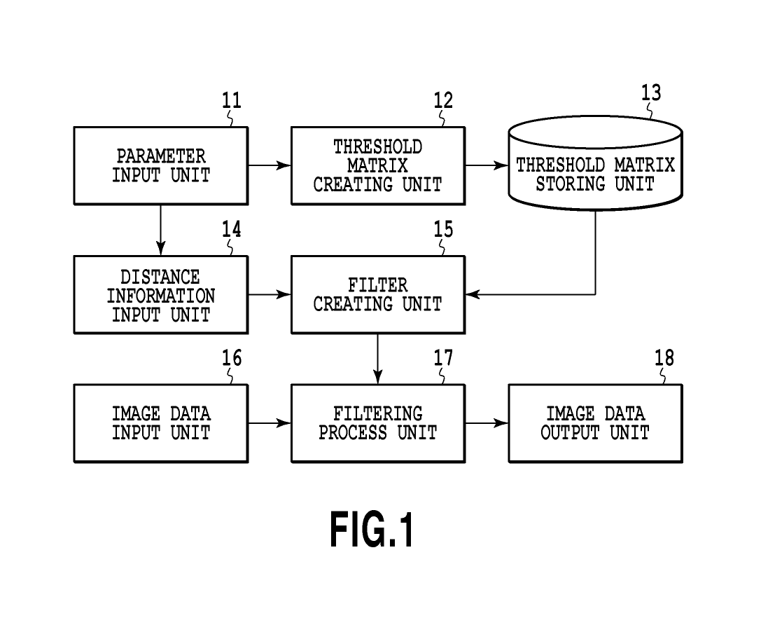

FIG. 1 is a view showing an example of a configuration of the image processing apparatus of the embodiment. The image processing apparatus includes a parameter input unit 11, a threshold matrix creating unit 12, a threshold matrix storing unit 13, a distance information input unit 14, a filter creating unit 15, an image data input unit 16, a filtering process unit 17, and an image data output unit 18.

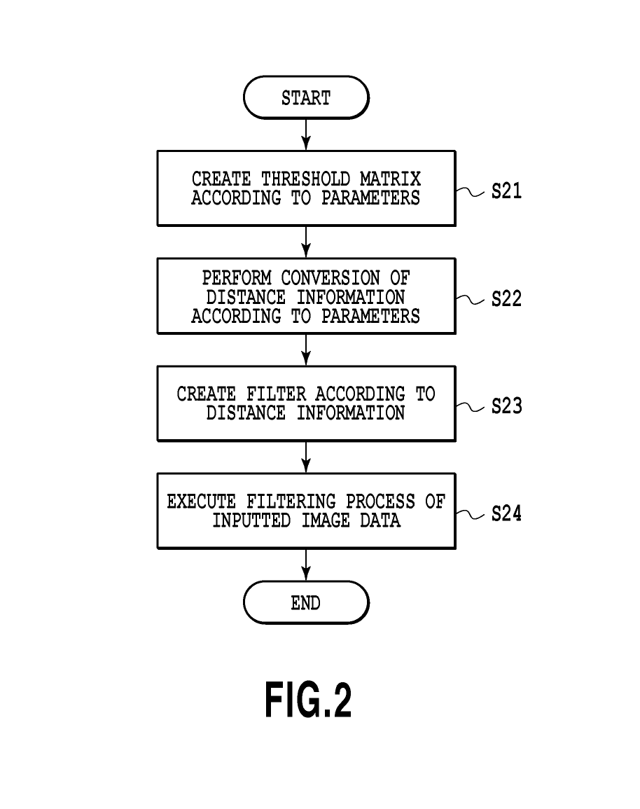

FIG. 2 is a view showing an example of a flow of the process in the image processing apparatus shown in FIG. 1. The process of the image processing apparatus is described below by using FIGS. 1 and 2. Specifically, description is given of an example of a process in which a filtering process is executed on image data inputted to the image data input unit 16, by using the depth information of an image shown by the inputted image data.

First in step S21, the parameter input unit 11 acquires parameters related to optical characteristics which are required for filter creation. Then, the threshold matrix creating unit 12 creates multiple thresholds related to the optical characteristics, according to the parameters acquired by the parameter input unit 11, and stores the created multiple thresholds in the threshold matrix storing unit 13. The multiple thresholds are created according to the depth information of the image shown by the image data subjected to the filtering process. Accordingly, the threshold can be the same for all of the pixels of the image subjected to the filtering process. Note that, although an example using the threshold matrix as the multiple thresholds is described in the following example, the multiple thresholds do not have to be a matrix. As will be described later, the multiple thresholds are used to determine the filter. Accordingly, the multiple thresholds can be of any mode as long as the multiple thresholds are thresholds used for the determination of filter.

The parameters of the embodiment include, for example, values which determines the depth of field such as distance data of a point of interest (a point desired to be in focus), an F-number, an effective aperture, actual distances corresponding to the maximum value and the minimum value of the distance data (or inverses of the distances). Moreover, distance data of each of the pixels in the image is acquired by the parameter input unit 11. Note that the threshold matrix represents a filter shape which changes according to the distance data. Details of the threshold matrix creation are described later.

In the embodiment, the distance data refers to the distance data acquired by the parameter input unit 11, and distance information to be described later refers to a value obtained by converting the distance data. In the embodiment, both of the distance data and the distance information correspond to the depth information.

Next, in step S22, the distance information input unit 14 acquires the distance data inputted to the parameter input unit 11 and converts the distance data into the distance information, according to the parameters indicating the depth of field which are inputted to the parameter input unit 11. Here, the distance data can be converted to a difference from the point of interest with the point of interest being zero. Moreover, it is preferable that the distance information is converted to an inverse (dioptre) of the actual distance in advance.

Next, in step S23, the filter creating unit 15 creates a filter according to the threshold matrix stored in the threshold matrix storing unit 13 and the distance information received from the distance information input unit 14. The details of the creation method are described later.

Lastly, in step S24, the image data input unit 16 acquires the image data and the filtering process unit 17 executes the filtering process on the image data acquired by the image data input unit 16, by using the filter created by the filter creating unit 15. Then, the image data output unit 18 outputs the image data having been subjected to the filtering process. In the example described above, it is assumed that the distance data of each pixel of the image shown by the image data inputted to the image data input unit 16 is calculated by a publicly-known method and is inputted to the parameter input unit 11.

In the configuration of the embodiment, various constituent elements other than those described above may exist. However, since such constituent elements are not the main point of the embodiment, description thereof is omitted.

### <Process of Threshold Matrix Creating Unit>

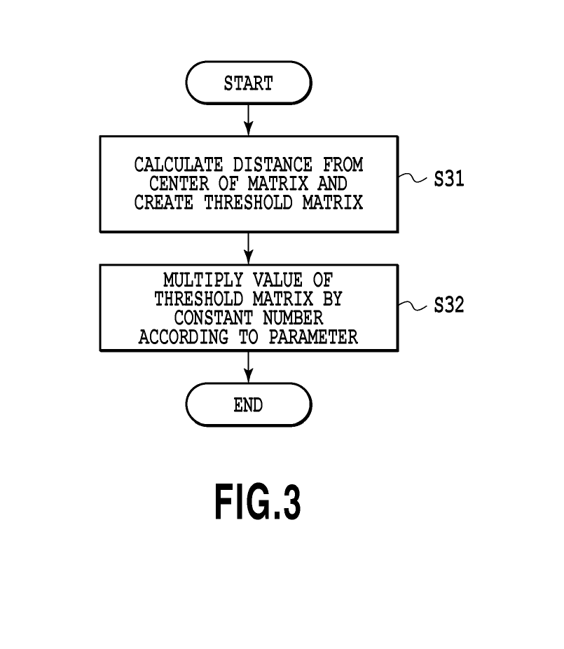

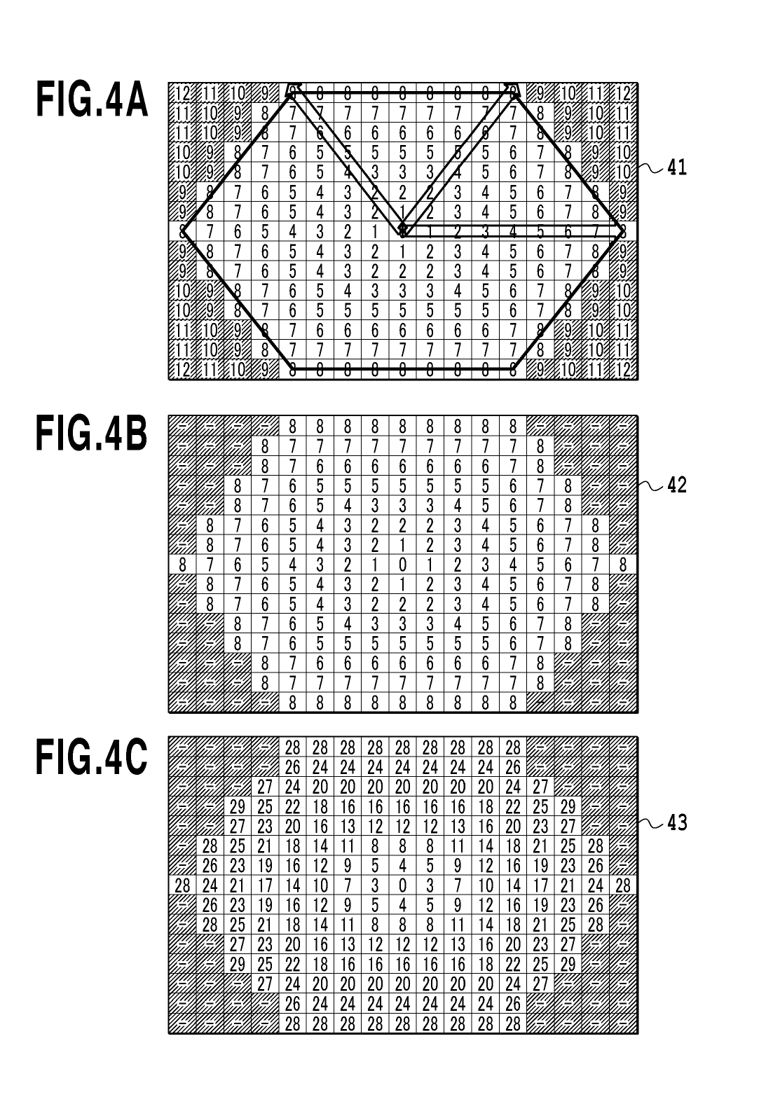

An example of a process of the threshold matrix creating unit 12 is described below by using the flowchart of FIG. 3 and examples of the threshold matrix in FIGS. 4A to 4C.

First, in step S31, the threshold matrix creating unit 12 calculates a distance from the center of a matrix having a predetermined shape and creates the threshold matrix. For example, in a case of a hexagonal filter, a threshold matrix 41 of FIG. 4A is created. Note that, in the threshold matrix 41 of FIG. 4A, actual numbers are rounded to integers to omit decimals for the sake of simplification. For example, the threshold matrix 41 of FIG. 4A can be obtained by performing calculation for a calculation result w(x,y) of the following formula, in a coordinate system (x,y) in which the center of the threshold matrix satisfies (x,y)=(0,0)

axe1=inv({{1,½},{0,sqrt(¾)}})

axe2=inv({{1,½},{0,−sqrt(¾)}})

axe3=inv({{½,½},{sqrt(¾),−sqrt(¾)}})

w(x,y)=min(sum(abs(axe1*{x,y}′)),sum(abs(axe2*{x,y}′)), sum(abs(axe3*{x,y}′))) (1)

In the above formula, { } represents an array or a matrix, inv represents an inverse matrix, sqrt represents a square root, abs represents an absolute value, sum represents a sum, min represents a minimum value, ′ represents a transpose of a matrix (change from a row vector to a column vector). Moreover, in a case where the filter shape is circular, the calculation can be performed by simply using the formula w(x, y)=sqrt(x*x+y*y). Furthermore, in order to determine the filter shape in a region where the blur is most intense, it is preferable to create a threshold matrix 42 shown in FIG. 4B in which values of the threshold matrix 41 exceeding a certain value (9 or more in this example) are deleted.

Next, in step S32, the threshold matrix creating unit 12 converts values defined in the created threshold matrix 42 of FIG. 4B, according to the parameters received from the parameter input unit 11. For example, the conversion is executed based on the following parameters: the value of the minimum value 0 of the distance information is 1/900 [1/mm]; the value of the maximum value 255 of the distance information is 1/300 [1/mm], the F-number is 3.5, the sensor size is 36 mm, the focal length is 35 mm, the image size is Full HD. As a result, the threshold matrix 42 of FIG. 4B is converted to a threshold matrix 43 of FIG. 4C.

In the conversion, since σ of a Gaussian filter can be calculated by using a formula of optical blur of a general lens as shown below, the size of the threshold matrix can be determined proportional to σ.

σ=f*f/F*abs(L−d)*width/sensorwidth (2)

In the above formula, f represents the focal length, F represents the F-number, L represents an inverse of the distance of the point of interest, d represents an inverse of the distance, width represents the image size [pixels], and sensorwidth represents the sensor size. In the case of the threshold matrix 43 of FIG. 4C, w′(x,y) is calculated in such a way that the radius corresponds to 2σ as shown below. However, the present invention is not limited to this.

w′(x,y)=w(x,y)÷(f*f/F*(( 1/300− 1/900)/255)*width/sensorwidth*2) (3)

### <Process of Filter Creating Unit>

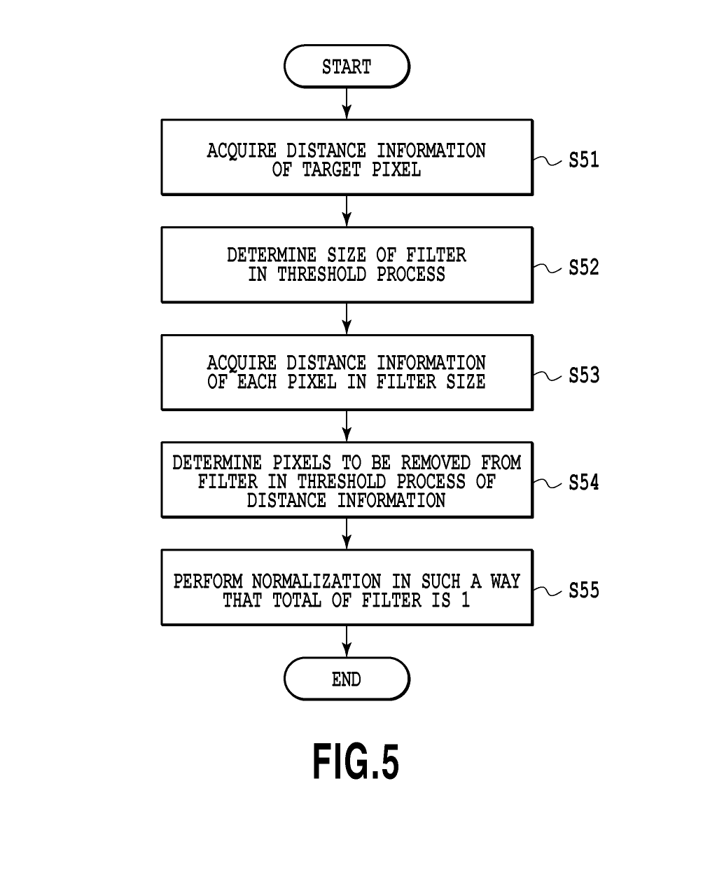

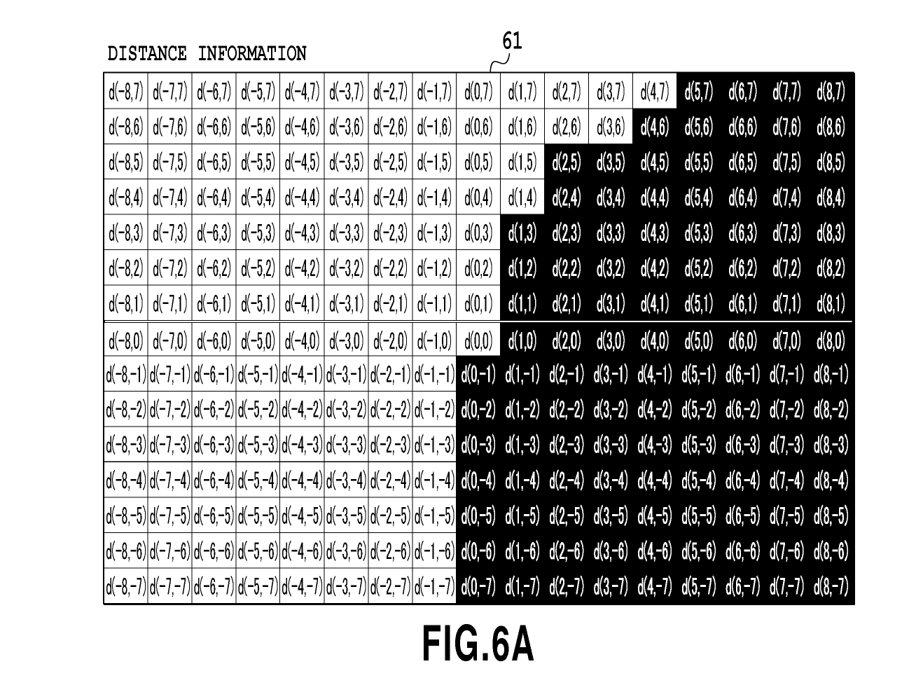

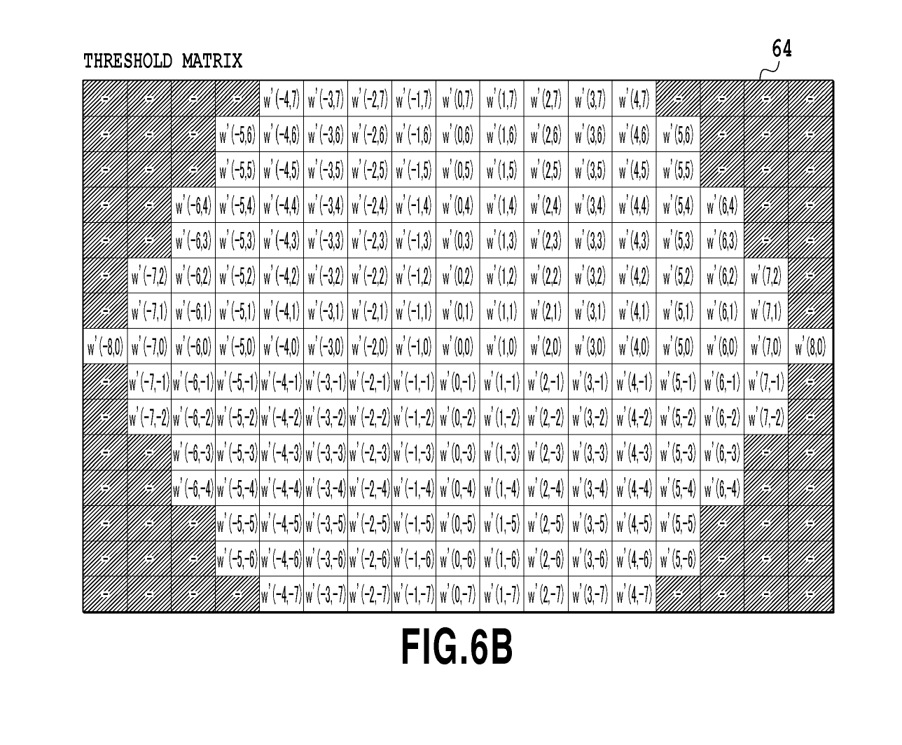

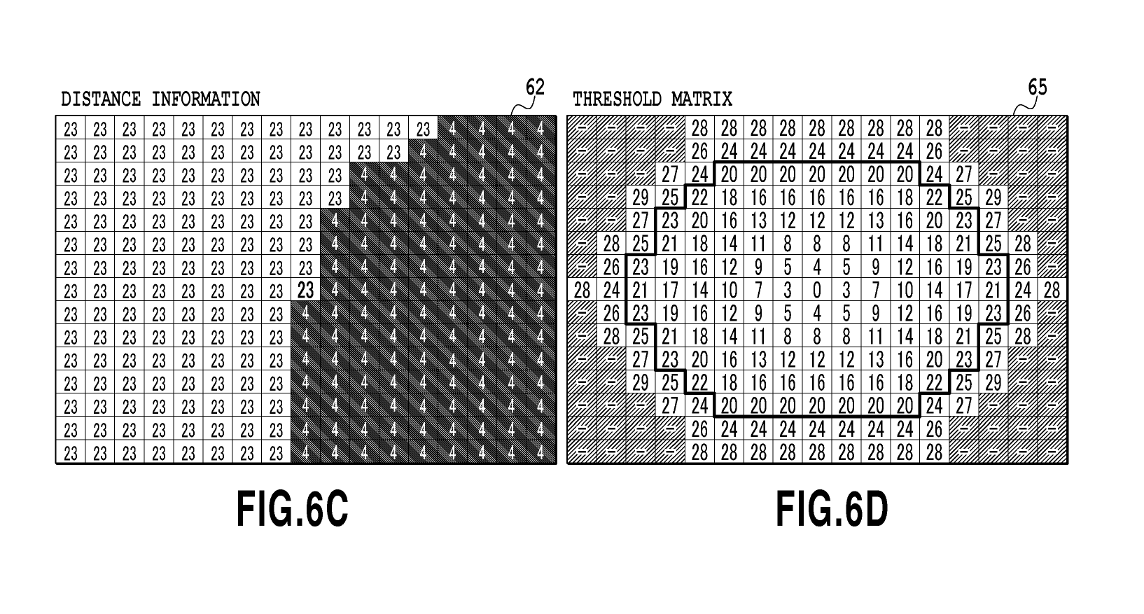

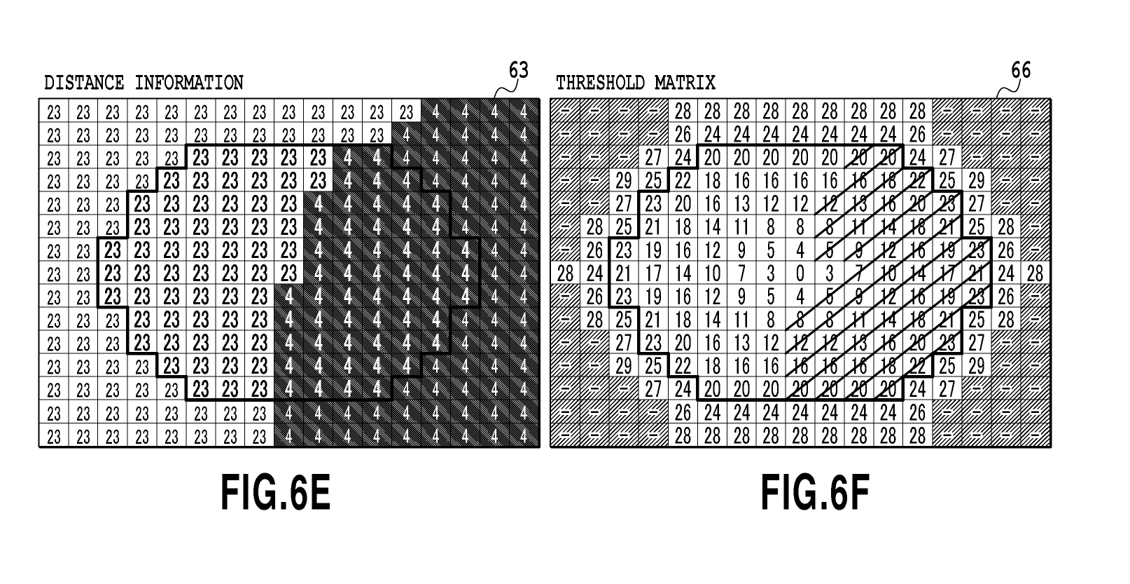

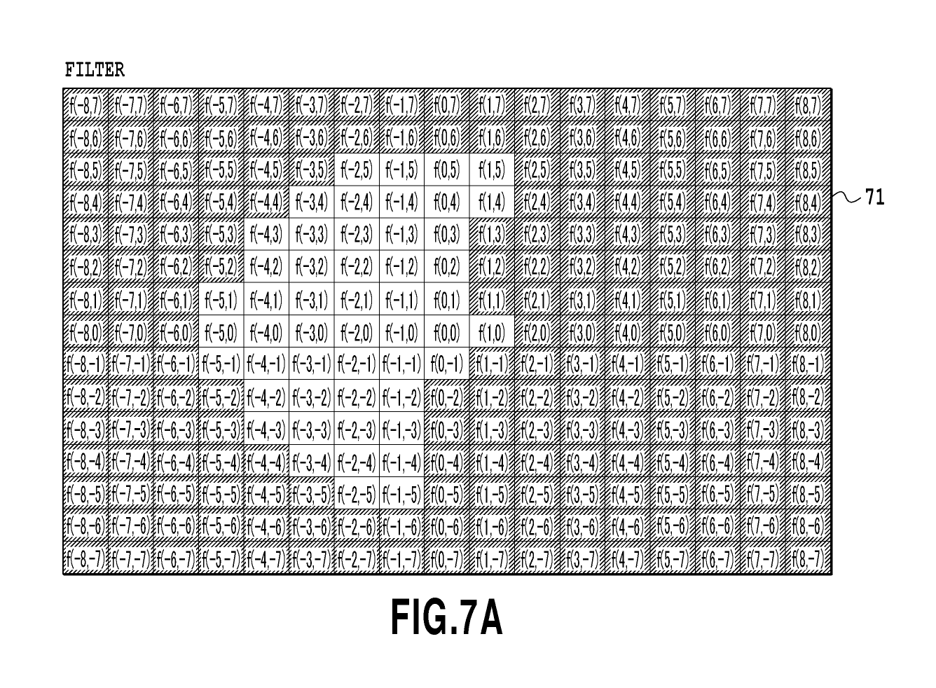

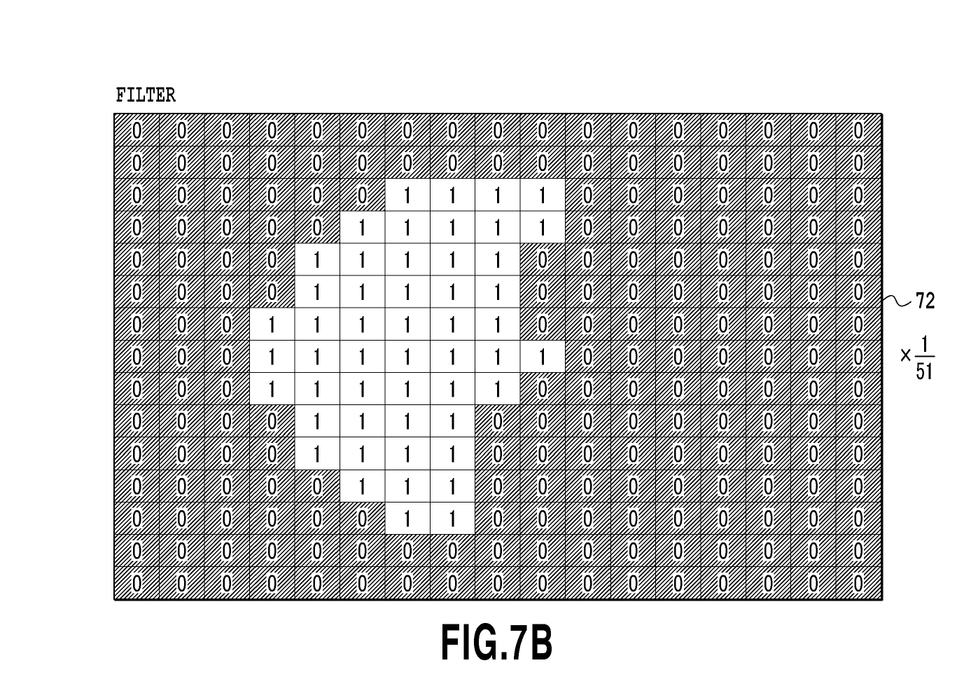

An example of a process of the filter creating unit 15 is described below by using the flowchart of FIG. 5 and the schematic views of FIGS. 6A to 7B. Note that the process of filter creating unit 15 described below is executed for all of the pixels included in the image with a target pixel changed.

First, in step S51, the filter creating unit 15 acquires the distance information of the target pixel from the distance information input unit 14. Here, the distance information of the position x,y sent from the distance information input unit 14 is described as d(x,y) as shown in distance information 61 of FIG. 6A and it is assumed that the target pixel is d(0,0) at the center. For example, as shown in distance information 62 of FIG. 6C, it is assumed that the target pixel d(0,0)=23 is satisfied and the target pixel is located on a boarder between the distance 23 and the distance 4. An example of creating a filter for the target pixel d(0,0)=23 is described below.

Next, in step S52, the filter creating unit 15 compares the distance information of the target pixel and the threshold matrix to determine the size of the filter. Here, values of the threshold matrix in which the center position is set to satisfy (x,y)=(0,0) as in threshold matrix 64 of FIG. 6B are each described as w′(x,y). In order to determine the size of the filter, the value d(0,0) of the target pixel in the distance information 61 of FIG. 6A and each of the thresholds w′(x,y) of the threshold matrix 64 in FIG. 6B are compared with each other, and a range in which the thresholds w′(x,y) are smaller than the value d(0,0) of the target pixel is set as the range of the filter. In other words, the closer the target pixel is to the point of interest, the smaller the filter created for the target pixel is, and the farther the target pixel is from the point of interest, the larger the filter created for the target pixel is. As a result, there is executed a filtering process in which an image becomes less blurred as the distance from the point of interest decreases and becomes more blurred as the distance from the point of interest increases. Making the size of the filter for each pixel variable as described above can save memory and increase the speed of process. In the example of the distance information 62 of FIG. 6C, in a case where, for example, the comparison with d(0,0)=23 of the distance information 62 of FIG. 6C is performed by using, as the values of w′(x,y), the same values as those in the threshold matrix 43 of FIG. 4C, the range of the filter is a portion surrounded by the black frame shown in a threshold matrix 65 of FIG. 6D. Note that this process is not limited to the comparison with the threshold matrix and, for example, the range of filter corresponding to the distance information can be acquired by using a LUT.

Next, in step S53, the filter creating unit 15 acquires the distance information of each pixel which is included in the image and which is within the filter range determined in step S52. For example, the distance information d(x,y) within the filter range determined in step S52 is acquired as shown in the bold letter portions of distance information 63 of FIG. 6E.

Then, in step S54, the filter creating unit 15 compares the distance information d(x, y) within the filter range and the corresponding threshold matrix w′ (x, y) with each other and removes pixels which satisfies d(x, y)<w′ (x, y) from the filter to determine the shape of the filter. For example, the pixels which satisfy d(x, y)<w′ (x, y) in the comparison between the distance information 63 of FIG. 6E and the threshold matrix 65 of FIG. 6D and which are thus removed from the filter range are pixels included a hatched portion of a threshold matrix 66 of FIG. 6F. As a result, the filter can be expressed in the following formula, provided that the filter is f (x, y) as shown in a filter 71 of FIG. 7A, 1 is set for pixels inside the filter range, and 0 is set for pixels outside the filter range.

$$\begin{matrix}f ( x , y ) = 1 ( {w}^{′} ( x , y ) <= d ( 0 , 0 ) and {w}^{′} ( x , y ) <= d ( x , y ) ) \\ = 0 ( other cases )\end{matrix} \qquad ( 4 )$$

As shown above, since pixels close to the point of interest are considered to be pixels in focus, these pixels are excluded as targets of the filtering process. Such a process can prevent unnatural blur of a portion in focus.

Lastly, in step S55, the filter creating unit 15 executes normalization in such a way that the total of filter is 1. For example, in a case where all of the weights in the filter range determined by the time of step S54 are uniform, a filter of weights of 1/51 is created in the filter range as shown in a filter 72 of FIG. 7B.

The process described above is repeatedly executed with the target pixel being changed and the filter creation according to distance information is thereby made possible.

In the embodiment, description is given of a configuration in which the filter is created by performing the determination of the filter size and then the determination of the filter shape and the created filter is outputted to the filtering process unit 17. However, the embodiment is not limited to this mode. For example, the filter creation and the filtering process can be simultaneously executed according to formula (4) by comparing the distance information and the threshold matrix, adding up pixels and weights included in the filter, and dividing the sum of pixels by the sum of weights.

Moreover, although the weights in the filter are uniform in the embodiment, the embodiment is not limited to this. For example, the weights maybe weights in a Gaussian function.

Furthermore, in the embodiment, there is given an example in which the values of the threshold matrix are converted by using the parameters and the depth of field is adjusted. However, instead of converting the values of the threshold matrix, it is possible to convert the distance information in a similar manner. Note that, however, it is preferable to convert the values of the threshold matrix in order to reduce the number of calculation steps.

Repeating the processes described above for each pixel in the distance information and the image data can achieve, in a simple configuration, a natural blurring process according to the depth even in a boundary portion where there is a difference in distance.

### Embodiment 2

In Embodiment 1, there is given an example of the blurring process according to depth. In the embodiment, there is shown an example of a sharpening process according to the depth.

Here, an example of an unsharp masking process is given. The unsharp masking process on a pixel value P of a process target can be expressed by the following formula (5) by using a process applied pixel value P′, a radius R of a blur filter, and an application amount A(%).

P′(i,j)=P(i,j)+(P(i,j)−F(i,j,R))*A/100 (5)

In formula (5), F(i,j,R) is a pixel value obtained by applying the blur filter of the radius R to the pixel P(i,j). A Gaussian blur is used as a blurring process in the embodiment. The Gaussian blur is a process of averaging in which weighting is performed by using Gaussian distribution according to a distance from the processing target pixel, and a natural process result can be obtained. Moreover, the radius R of the blur filter relates to the wavelength of a cycle in the image to which the sharpening process is to be applied. In other words, finer patterns are enhanced as the radius R becomes smaller and coarser patterns are enhanced as the radius R becomes larger.

In the embodiment, the size of the blur filter of the unsharp masking process is large in a case where the target pixel is at a close distance from the point of interest, and is small in a case where the target pixel is at a far distance from the point of interest. In other words, this is the opposite of the relationship between the distance information and the filter size in Embodiment 1. Accordingly, even if a pattern desired to be enhanced is at a far distance and is thus small, the pattern can be enhanced in a way suiting the pattern.

Since outlines of a configuration of an image processing apparatus and an image processing method of Embodiment 2 can be the same as those shown in FIGS. 1 and 2, description thereof is omitted.

### <Process of Threshold Matrix Creating Unit>

In Embodiment 2, in a threshold matrix, the size of the sharpening filter can be arbitrary designated according to the distance. For example, in a case where the size is determined proportional to the distance information, the size is determined as follows by using w(x,y) obtained in formula (1).

w′(x,y)=α−β*w(x,y) (6)

### <Process of Filter Creating Unit>

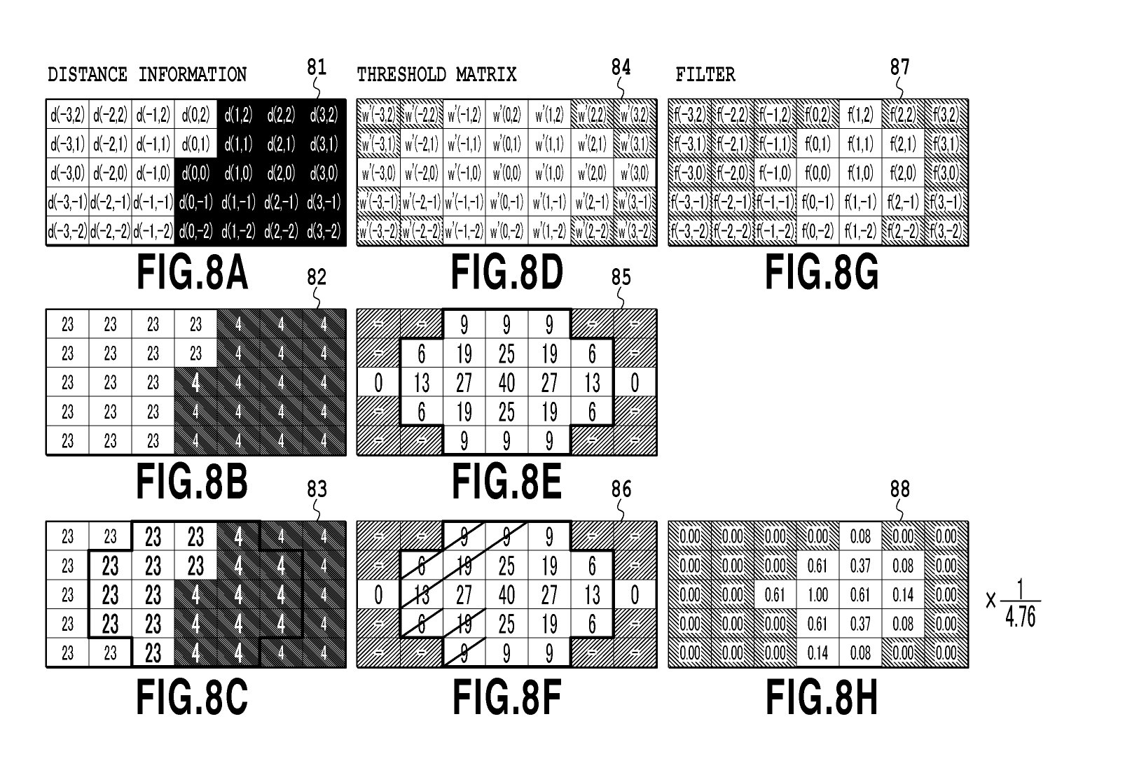

An example of a filter creating unit 15 is described below by using the flowchart of FIG. 5 and the schematic views of FIGS. 8A to 8H. Note that a filter created by this flowchart is a filter for the Gaussian blur portion of the unsharp masking process.

Since step S51 is the same as that in Embodiment 1, description thereof is omitted. Like the distance information 61 of FIG. 6A of Embodiment 1, the distance information is expressed as d (x, y) with the center position being (x, y)=(0,0) as shown in distance information 81 of FIG. 8A. Here, an actual example is d(0,0)=4 as shown in distance information 82 of FIG. 8B.

Next, in step S52, the filter creating unit 15 determines the size of the filter by comparing the distance information of the target pixel and the threshold matrix with each other. Like the threshold matrix 64 of FIG. 6B of Embodiment 1, thresholds of a threshold matrix 84 of FIG. 8D are each described as w′(x,y). In order to determine the size of the filter, the value d(0,0) of the target pixel in the distance information 81 of FIG. 8A and each of the thresholds w′(x,y) of the threshold matrix 84 of FIG. 8D are compared with each other, and a range in which the thresholds w′(x,y) are larger than the value d(0,0) of the target pixel is set as the range of the filter. For example, in a case where the values of w′(x,y) are the values of a threshold matrix 85 of FIG. 8E and the comparison with the d(0,0)=4 of the distance information 82 of FIG. 8B is performed, the range of the filter is a portion surrounded by the black frame as shown in the threshold matrix 85 of FIG. 8E. Note that this process is not limited to the comparison with the threshold matrix and, for example, the range of filter corresponding to the distance information can be acquired by using a LUT.

Next, in step S53, the filter creating unit 15 acquires the distance information in the filter range. For example, the distance information d(x,y) within the filter range determined in step S52 is acquired as shown in the bold letter portions of distance information 83 of FIG. 8C.

Then, in step S54, the filter creating unit 15 compares the distance information d(x,y) within the filter range and the corresponding threshold matrix w′(x,y) with each other and removes pixels which satisfies d(x,y)>w′(x,y) from the filter. For example, the pixels which satisfy d(x,y)>w′(x,y) in the comparison between the distance information 83 of FIG. 8C and the threshold matrix 85 of FIG. 8E and which are thus removed from the filter range are pixels included a hatched portion of a threshold matrix 86 of FIG. 8F. As a result, the filter can be expressed in the following formula, provided that the filter is f(x,y) as shown in a filter 87 of FIG. 8G, 1 is set for pixels inside the filter range, and 0 is set for pixels outside the filter range.

$$\begin{matrix}f ( x , y ) = 1 ( {w}^{′} ( x , y ) >= d ( 0 , 0 ) and {w}^{′} ( x , y ) >= d ( x , y ) ) \\ = 0 ( other cases )\end{matrix} \qquad ( 7 )$$

Here, the weight is a Gaussian function. Accordingly, assuming that the Gaussian function of σ=1 is used, the filter is expressed in the following formula.

$$\begin{matrix}f ( x , y ) = exp ( - ( x ⋀ 2 + y ⋀ 2 ) ) \\ ( {w}^{′} ( x , y ) >= d ( 0 , 0 ) and {w}^{′} ( x , y ) >= d ( x , y ) ) \\ = 0 ( other cases )\end{matrix} \qquad ( 8 )$$

It is preferable that a value σ of a Gaussian weight changes depending on the distance d(0,0).

Lastly, in step S55, the filter creating unit 15 executes normalization in such a way that the total of filter is 1. For example, in a case of the filter weight of formula (7), the filter is created by dividing formula (8) by 4.76 as shown in a filter 88 of FIG. 8H.

The creation of the filter for the Gaussian blur portion of the unsharp masking process according to the distance information is thus made possible.

The creation of the filter for the unsharp masking process as in formula (5) is performed according to the following formula.

$$\begin{matrix}f\_sharp ( x , y ) = 1 + ( 1 - f ( x , y ) ) * A / 100 ( x = 0 , y = 0 ) \\ = - f ( x , y ) * A / 100 ( other cases )\end{matrix} \qquad ( 9 )$$

Here, a real number α is a parameter for adjusting edge enhancement.

Moreover, in the process described above, the filter creation and the filtering process can be simultaneously executed as in Embodiment 1.

Repeating the processes described above for each pixel in the distance information and the image data can achieve, in a simple configuration, a natural sharpening process according to the depth even in a boundary portion where there is a difference in distance.

The example of the configuration of the image processing apparatus has been thus described. Note that a computer may be incorporated in the image processing apparatus described above. The computer includes: a main control unit such as a CPU; and a storage unit such as ROM (Read Only Memory), RAM (Random Access Memory), and HDD (Hard Disk Drive). Moreover, the computer includes other units as: an input-output unit such as a keyboard, a mouse, a display, and a touch panel; and a communication unit such as a network card. These constituent units are connected to each other by a bus or the like and are controlled by the main control unit executing a program stored in the storage unit.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-188785, filed Aug. 29, 2012, which is hereby incorporated by reference herein in its entirety.

What is claimed is:

1. An image processing apparatus comprising:
a determination unit configured to determine a filter for a target pixel by comparing a plurality of thresholds relating to an optical characteristic of an image capturing unit and a plurality of values representing distances to a subject in the target pixel and pixels around the target pixel; and
a filter unit configured to apply the filter to the target pixel.

2. The image processing apparatus according to claim 1, wherein the optical characteristic represents the depth of field.

3. The image processing apparatus according to claim 1, wherein the optical characteristic relates to at least one of distance data of a point of interest, an F-number, an effective aperture, actual distances corresponding to a maximum value and a minimum value of the distance data.

4. The image processing apparatus according to claim 1, wherein the determination unit changes a size of the filter to be applied to the target pixel, according to the plurality of values representing distances to a subject in the target pixel and pixels around the target pixel.

5. The image processing apparatus according to claim 1, wherein the determination unit changes a shape of the filter to be applied to the target pixel, according to distance to a subject in the target pixel and distance to the subject in the pixels around the target pixel.

6. The image processing apparatus according to claim 1, wherein values defined in the plurality of thresholds are values converted according to the optical characteristic.

7. The image processing apparatus according to claim 1, wherein the filtering unit uses a smoothing filter.

8. The image processing apparatus according to claim 1, wherein the filtering unit uses a sharpening filter.

9. An image processing apparatus comprising:
a determination unit configured to determine a filter for a target pixel on the basis of information representing an optical characteristic of an image capturing unit and information representing distances to a subject in the target pixel and pixels around the target pixel; and
a filter unit configured to apply the filter to the target pixel, wherein
a size of the filter is determined based on a difference between a distance in focus and a distance to a subject.

10. An image processing apparatus comprising:
a determination unit configured to determine a filter for a target pixel on the basis of information representing an optical characteristic of an image capturing unit and information representing distances to a subject in the target pixel and pixels around the target pixel; and
a filter unit configured to apply the filter to the target pixel, wherein
a shape of the filter is determined based on a difference between a distance in focus and a distance to a subject.

11. An image processing method comprising:
a determination step of determining a filter for a target pixel by comparing a plurality of thresholds relating to an optical characteristic of an image capturing unit and a plurality of values representing distances to a subject in the target pixel and pixels around the target pixel; and
a filter step of applying the filter to the target pixel.

12. An image processing method comprising:
a determination step of determining a filter for a target pixel on the basis of information representing an optical characteristic of an image capturing unit and information representing distances to a subject in the target pixel and pixels around the target pixel; and
a filter step of applying the filter to the target pixel, wherein
a size of the filter is determined based on a difference between a distance in focus and a distance to a subject.

13. An image processing method comprising:
a determination step of determining a filter for a target pixel on the basis of information representing an optical characteristic of an image capturing unit and information representing distances to a subject in the target pixel and pixels around the target pixel; and
a filter step of applying the filter to the target pixel, wherein
a shape of the filter is determined based on a difference between a distance in focus and a distance to a subject.

14. A non-transitory computer readable storage medium storing a program which causes a computer to perform an image processing method according to claim 11.

15. A non-transitory computer readable storage medium storing a program which causes a computer to perform an image processing method according to claim 12.

16. A non-transitory computer readable storage medium storing a program which causes a computer to perform an image processing method according to claim 13.
